(19) United States
(12) Patent Application Publication
(10) Pub. No.: US 2026/0342081 A1
(43) Pub. Date: Oct. 29, 2026

(54) ENERGY STORAGE MODULE, POWER SUPPLY SYSTEM, AND METHOD OF CONTROLLING THE ENERGY STORAGE MODULE

(71) Applicant: DELTA ELECTRONICS (THAILAND) PUBLIC COMPANY LIMITED, Amphur Muang (TH)

(72) Inventors: Min XU, Shanghai (CN); Yexuan ZHENG, Shanghai (CN); Kai DONG, Shanghai (CN)

(21) Appl. No.: 19/335,751

(22) Filed: Sep. 22, 2025

(30) Foreign Application Priority Data
Apr. 23, 2025 (CN) 202510523391.3

(51) Int. Cl. H02J 1/14; H02J 7/00; H02J 7/96; H02M 3/158

(52) U.S. Cl. CPC H02J 1/14; H02J 7/865; H02J 7/96; H02M 3/158; H02J 2207/20; H02J 2207/50

(57) ABSTRACT

An energy storage module, a power supply system, and a method of controlling the energy storage module are disclosed. The energy storage module includes a bidirectional DC-to-DC converter and an energy storage unit. A first terminal of the bidirectional DC-to-DC converter is connected to the energy storage unit. The method includes: controlling an operation mode of the energy storage module according to a current-sharing bus signal provided by a power module connected to a second terminal of the bidirectional DC-to-DC converter. The energy storage module is used to compensate fluctuations of an input current of the power module.

### BACKGROUND

### Technical Field

The present disclosure relates to a field of power supplies, and more particularly to an energy storage module, a power supply system, and a method of controlling the energy storage module.

### Description of Related Art

The statements in this section merely provide background information related to the present disclosure and do not necessarily constitute prior art.

In applications of server power supplies, the common structure of the power module (also referred to as “power supply unit”, PSU) is a two-stage topology: the front stage is a power factor correction circuit (PFC), and the rear stage is a direct-current to direct-current (DC-to-DC) converter.

With the development of AI (artificial intelligence) and high-performance computing, the power consumption of components such as graphics processing units (GPUs) and central processing units (CPUs) in servers is also increasing. As the demand for high-performance computing increases, server power supply systems need to cope with higher power requirements, higher heat dissipation capabilities, and more stable voltage control requirements, and require more intelligent power management systems to ensure their stable operation.

Since AI (artificial intelligence) loads frequently experience large fluctuations, the output power of the server power supply fluctuates dramatically. Therefore, discontinuities in the AC input waveform may introduce undesired noise into the power supply network, thereby impacting the power quality on the input side.

Therefore, how to design an energy storage module, a power supply system, and a method of controlling the energy storage module that can achieve peak shaving and valley filling when the load of the power module experiences large fluctuations, thereby avoiding a sudden change in the input current of the power module has become a critical topic in this field.

### SUMMARY

An objective of the present disclosure is to provide a method of controlling an energy storage module to solve the problems of existing technologies.

In order to achieve the above-mentioned objective, the energy storage module includes a bidirectional DC-to-DC converter and an energy storage unit. A first terminal of the bidirectional DC-to-DC converter is connected to the energy storage unit. The method includes: controlling an operation mode of the energy storage module according to a current-sharing bus signal provided by a power module connected to a second terminal of the bidirectional DC-to-DC converter. The energy storage module is used to compensate an input current fluctuation of the power module.

In one embodiment, the method further includes: controlling the energy storage module to enter a pre-charging mode to pre-charge the energy storage unit after the energy storage module is connected to the power module; controlling the energy storage module to enter a standby mode when a voltage of the energy storage unit is charged to a preset value, and in the standby mode, controlling the energy storage unit to be charged or to discharge to the power module according to the current-sharing bus signal.

In one embodiment, the method further includes: sampling the current-sharing bus signal to acquire a current-sharing bus sampling signal, and controlling the operation mode of the energy storage module according to a difference between a reference signal and the current-sharing bus sampling signal.

In one embodiment, the method further includes: generating a current reference signal corresponding to the bidirectional DC-to-DC converter according to the difference between the reference signal and the current-sharing bus sampling signal, and controlling the operation mode of the energy storage module according to the current reference signal and an inductor current of the bidirectional DC-to-DC converter.

In one embodiment, the method further includes: in a pre-charging mode, setting the reference signal to k times a rated value of the current-sharing bus signal, and k being less than 1, wherein the rated value of the current-sharing bus signal represents an output current of the power module outputting rated power.

In one embodiment, in a standby mode, the reference signal represents an average power of the power module.

In one embodiment, the method further includes: in the pre-charging mode, controlling a current of charging the energy storage unit from the power module not to exceed a predetermined current-limiting value.

In one embodiment, the predetermined current-limiting value is a fixed value.

In one embodiment, the predetermined current-limiting value is a first current-limiting value with a fixed value in a first pre-charging stage, and the predetermined current-limiting value is a value related to a power value of the power module charging the energy storage unit and/or a value related to a voltage of the energy storage unit in a second pre-charging stage.

In one embodiment, the method further includes: controlling the energy storage module to enter the first pre-charging stage when the voltage of the energy storage unit is less than a first voltage threshold, and controlling a current of charging the energy storage unit from the power module not to exceed the first current-limiting value during the first pre-charging stage.

In one embodiment, the method further includes: controlling the energy storage module to enter the second pre-charging stage when the voltage of the energy storage unit reaches the first voltage threshold, and controlling a current of charging the energy storage unit from the power module not to exceed a ratio between a first power threshold and the voltage of the energy storage unit.

In one embodiment, the method further includes: controlling the first power threshold to gradually increase from the power value of charging the energy storage unit by the power module at the end of the first pre-charging stage to a maximum power limit when entering the second pre-charging stage.

In one embodiment, the method further includes: charging the energy storage unit at the maximum power limit until the voltage of the energy storage unit reaches a third voltage threshold when the power value of charging the energy storage unit by the power module reaches the maximum power limit, and then controlling the first power threshold to gradually decrease from the maximum power limit until the voltage of the energy storage unit reaches the preset value, thereby gradually exiting the pre-charging mode.

In one embodiment, the method further includes: in the standby mode, controlling the energy storage unit to operate in the discharging mode when the current-sharing bus sampling signal is greater than the reference signal so that the energy storage unit releases energy to the load; controlling the energy storage unit to operate in the charging mode when the current-sharing bus sampling signal is less than the reference signal so that the power module stores energy in the energy storage unit.

Another objective of the present disclosure is to provide an energy storage module to solve the problems of existing technologies.

In order to achieve the above-mentioned objective, the energy storage module includes a bidirectional DC-to-DC converter and an energy storage unit. A first terminal of the bidirectional DC-to-DC converter is connected to the energy storage unit, and a second terminal of the bidirectional DC-to-DC converter is connected to an output terminal of a power module; each energy storage module further includes a controller, and the controller executes the above-mentioned method.

Further another objective of the present disclosure is to provide a power supply system to solve the problems of existing technologies.

In order to achieve the above-mentioned objective, the power supply system includes at least one power module and at least one energy storage module. An output terminal of each power module is connected in parallel to a load, wherein each power module converts its own output current into a voltage signal to a current-sharing bus. An output terminal of each energy storage module is connected together, and each energy storage module includes a bidirectional DC-to-DC converter and an energy storage unit. A first terminal of the bidirectional DC-to-DC converter is connected to the energy storage unit, and a second terminal of the bidirectional DC-to-DC converter is connected to the output terminal of the power module. Each energy storage module further includes a controller, and the controller executes the above-mentioned method; wherein the voltage signal on the current-sharing bus is the current-sharing bus signal.

In one embodiment, the at least one power module is disposed in the same power shelf.

In one embodiment, the at least one energy storage module is disposed in the same power shelf.

Accordingly, the present disclosure has the following features and advantages: 1. By providing or receiving current through the energy storage module 20, the output current of the power module 10 does not need to rapidly increase or decrease in a short period of time. As a result, the power module 10 does not need to quickly increase or decrease the current drawn from its input power source so that the input current of the power module 10 can be maintained unchanged or without a sudden change, thereby reducing the impact on the power grid; 2. It is to prevent the energy storage unit 22 from causing the overload of the power module 10 during the pre-charging process; 3. It is to prevent the energy storage unit 22 from causing a sudden change in the input current of the power module 10 during the pre-charging process; 4. The energy storage unit 22 is kept to have a normal service life with the method for the pre-charging process.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a power supply system including a power module and an energy storage module according to the present disclosure.

FIG. 2 is a circuit diagram of the energy storage module according to the present disclosure.

FIG. 3 is a schematic block diagram of a single power module and a single energy storage module according to the present disclosure.

FIG. 4 is a schematic block diagram of multiple power modules and multiple energy storage modules according to the present disclosure.

FIG. 5 is a block diagram of a control loop of pre-charging an energy storage unit according to the present disclosure.

FIG. 6 is a work waveform diagram of pre-charging the energy storage unit according to the present disclosure.

FIG. 7 is a flowchart of a method of controlling the energy storage module according to the present disclosure.

FIG. 8 is a flowchart of the method of controlling the energy storage module in detail according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

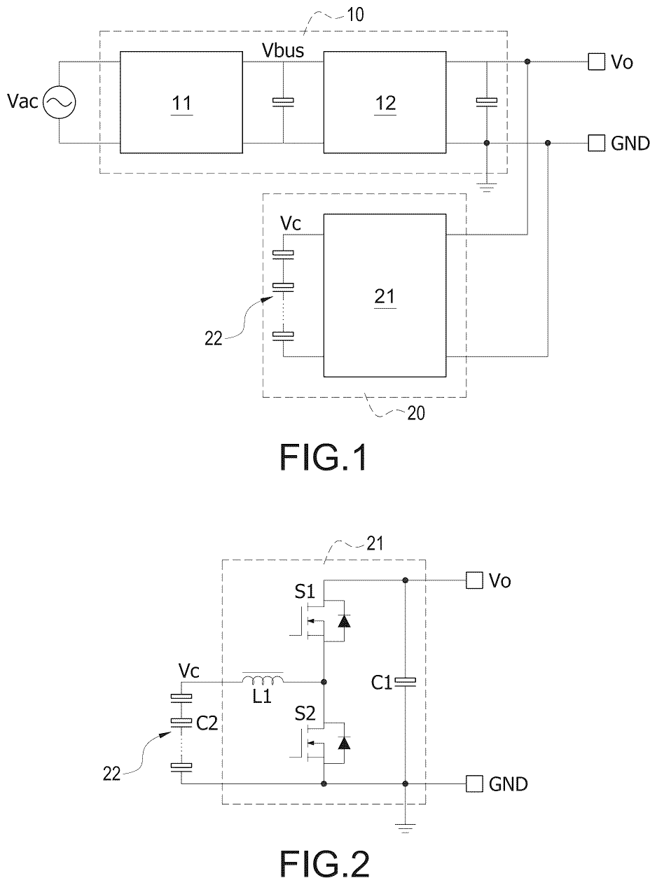

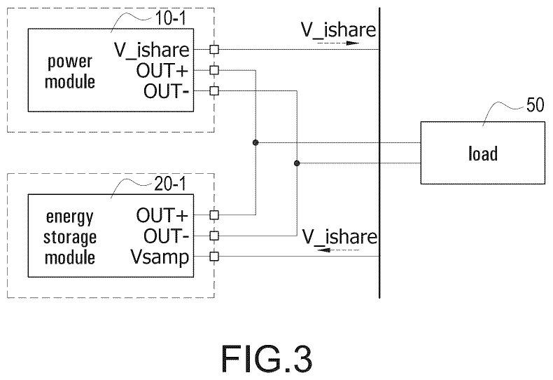

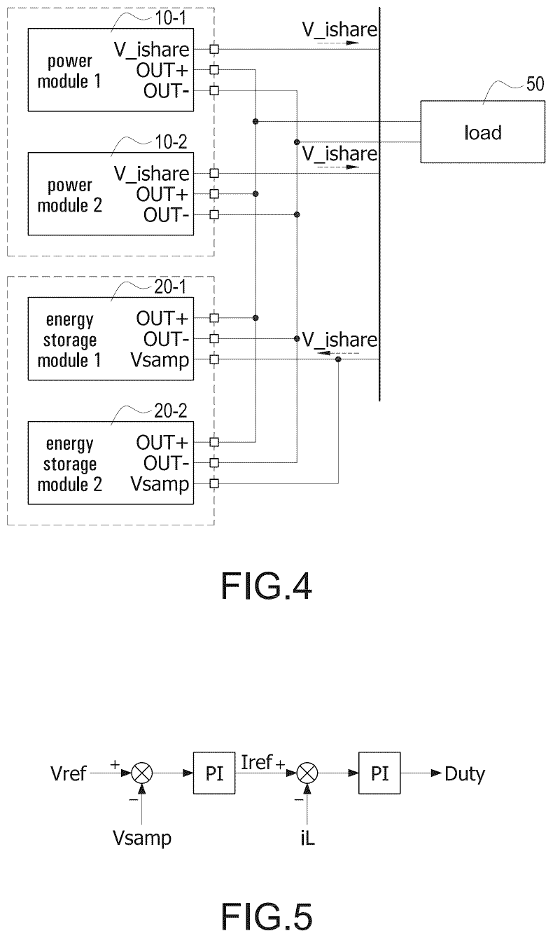

Please refer to FIG. 1, which shows a block circuit diagram of a power supply system including a power module and an energy storage module according to the present disclosure. The power supply system includes at least one power module (also referred to as “power supply unit”, PSU) 10 and at least one energy storage module 20. The power module 10 includes, for example but not limited to, a front-stage power factor correction circuit (PFC) 11 and a rear-stage direct-current to direct-current (DC-to-DC) converter 12. The front-stage power factor correction circuit (PFC) 11 receives an alternating-current (AC) power source Vac, and converts the AC power source Vac into a DC power source. The DC power source is then converted by the rear-stage DC-to-DC converter 12 to be output. In particular, an output side of the rear-stage DC-to-DC converter 12 is connected to a load 50 (may be referred in FIG. 3 or FIG. 4) to supply power to the load 50. In some embodiment, the rear-stage DC-to-DC converter 12 may also be a single-stage AC-to-DC converter.

The energy storage module 20 mainly includes a bidirectional DC-to-DC converter 21 and an energy storage unit 22. The bidirectional DC-to-DC converter 21 may have many structures. The present disclosure is described by taking a common bidirectional buck/boost converter as an example, but the present disclosure is not limited thereto. Similarly, the energy storage unit 22 may be implemented by many energy storage components with energy storage function. The present disclosure is described by taking the energy storage component as the energy storage capacitor C2 (may be referred in FIG. 2) as an example, but the present disclosure is not limited thereto. In addition, the energy storage capacitor C2 may be, for example, a supercapacitor.

Specifically, each energy storage module 20 includes a bidirectional DC-to-DC converter 21 and an energy storage unit 22. A first terminal of the bidirectional DC-to-DC converter 21 is connected to the energy storage unit 22. A second terminal of the bidirectional DC-to-DC converter 21 is connected to the output terminal of the power module 10. Each energy storage module 20 further includes a controller, and the controller is used to control the energy storage module 20.

Specifically, if the load 50 is too heavy and without the energy storage module 20, an input current of the power module 10 will be too high. When the energy storage module 20 is added, the energy storage module 20 is controlled to operate in a discharging mode, so that the energy storage unit 22 releases energy to the load 50 through the bidirectional DC-to-DC converter 21, and supplies power to the load 50 together with the power module 10, thereby maintaining the input current of the power module 10 unchanged. On the contrary, when the load 50 is too light, the energy storage module 20 is controlled to operate in a charging mode, so that the excess input power is delivered to the energy storage unit 22 through the bidirectional DC-to-DC converter 21 to charge the energy storage unit 22, thereby maintaining the input current of the power module 10 unchanged. Therefore, by providing or receiving current through the energy storage module 20, the output current of the power module 10 does not need to rapidly increase or decrease in a short period of time. As a result, the power module 10 does not need to quickly increase or decrease the current drawn from its input power source so that the input current of the power module 10 can be maintained unchanged, thereby reducing the impact on the power grid.

Please refer to FIG. 2, which shows a circuit diagram of the energy storage module according to the present disclosure. As mentioned above, the bidirectional DC-to-DC converter 21 of the energy storage module 20 is described by taking a bidirectional buck/boost converter as an example. The bidirectional DC-to-DC converter 21 includes an inductor L1, a first switch S1, a second switch S2, and a capacitor C1. When the energy storage module 20 operates in the discharging mode, the bidirectional DC-to-DC converter 21 operates in a boost state; when the energy storage module 20 operates in the charging mode, the bidirectional DC-to-DC converter 21 operates in a buck state. It should be noted that, in other embodiments, the opposite situation may also occur, which depends on the configuration of the energy storage unit 22.

Please refer to FIG. 3, which shows a schematic block diagram of a single power module and a single energy storage module according to the present disclosure. The power module 10-1 correspondingly converts its own output current into a voltage signal and connects it to a current-sharing bus. The voltage signal on the current-sharing bus is referred to as a current-sharing bus signal V_ishare. For example, according to the specification requirements of ORV3 (Open Rack Standard V3 or Open Compute Project Rack Standard V3), when the power module 10-1 generates 50% of the rated current, the current-sharing bus signal V_ishare is 3.5 volts; when the power module 10-1 generates 100% of the rated current, the current-sharing bus signal V_ishare is 7 volts. The energy storage module 20-1 can acquire the corresponding load information by simply sampling the current-sharing bus signal V_ishare on the current-sharing bus. In general, the current-sharing bus signal V_ishare is a signal that is positively correlated with the current value of the output current of the power module 10-1, so that the energy storage module 20-1 can estimate the condition of the load 50 according to the current-sharing bus signal V_ishare provided by the power module 10-1. For example, when the signal value of the current-sharing bus signal V_ishare is large, it represents that the load 50 needs more power. On the contrary, when the signal value of the current-sharing bus signal V_ishare is small, it represents that the load 50 needs less power. When a change rate of the signal value of the current-sharing bus signal V_ishare is large, it represents that the load 50 rapidly increases or decreases. Therefore, by utilizing the current-sharing bus signal V_ishare, there is no need to use additional devices to sample the output current of the power module 10-1 to acquire the load information. Usually, since the power module 10-1 is a packaged as a whole and no position is reserved for current sampling, the load information is cleverly acquired by utilizing the existing information of the power module 10-1.

Please refer to FIG. 4, which shows a schematic block diagram of multiple power modules and multiple energy storage modules according to the present disclosure. Compared with the single power module 10-1 and the single energy storage module 20-1 shown in FIG. 3, FIG. 4 illustrates that multiple (i.e., two) power modules 10-1, 10-2 in parallel and multiple (i.e., two) energy storage modules 20-1, 20-2 in parallel work in coordination. In the parallel power module structure, output terminals of each power module are connected together to the load 50, and output terminals of each energy storage module are connected together to the output terminals of each power module. Also, each power module 10-1, 10-2 will convert its own output current into a corresponding voltage signal, and multiple voltage signals will be connected to a common current-sharing bus. In general, for a system with multiple power modules connected in parallel, there is usually a requirement for current sharing, and therefore each power module 10-1, 10-2 will compare its own output current with the current-sharing bus signal V_ishare on the common current-sharing bus to make corresponding adjustments to achieve the purpose of current sharing. For example, if the voltage signal corresponding to the output current of the power module 10-1 is lower than the current-sharing bus signal V_ishare on the current-sharing bus, it represents that the current supplied by the power module 10-1 is less. In this condition, the control circuit will control the power module 10-1 to generate more power to increase its output current, and vice versa. Therefore, the currents output by the power modules 10-1, 10-2 tend to be the same to achieve the purpose of current sharing, thereby realizing load sharing, that is, the current-sharing bus signal V_ishare may represent the average load information of multiple power modules.

Furthermore, by the coordinated operation of the two energy storage modules 20-1, 20-2 and the two power modules 10-1, 10-2, when the load 50 is too heavy, the energy storage modules 20-1, 20-2 are controlled to operate in the discharging mode to release energy to the load 50; alternatively, when the load 50 is too light, the energy storage modules 20-1, 20-2 are controlled to operate in the charging mode, so that the excess input power charges the energy storage units 22 of the energy storage modules 20-1, 20-2, thereby maintaining the input currents of the power modules 10-1, 10-2 unchanged. In addition, although two power modules and two energy storage modules are used as an example for explanation, it should be understood that the number of power modules and the number of energy storage modules are not in a one-to-one correspondence, and both can be designed according to the requirements of the load 50. In other embodiments, multiple power modules are connected in parallel and placed in the same power shelf, and multiple energy storage modules are connected in parallel and placed in the same power shelf, and both are placed in a power rack.

Please refer to FIG. 7, which shows a flowchart of a method of controlling the energy storage module according to the present disclosure, and also refer to FIG. 1 to FIG. 4. The control method proposed in the present disclosure is used to control the energy storage module (taking the energy storage module 20 shown in FIG. 1 as an example, but the present disclosure is not limited thereto) to compensate the fluctuations of an input current of the power module 10, that is, the input current of the power module 10 can be maintained unchanged or without sudden charges regardless of whether the load 50 is too heavy or too light, or even increases or decreases rapidly. The method of controlling the energy storage module 20 include the following steps. First, the power module 10 provides a current-sharing bus signal V_ishare (step S10). Afterward, the operation mode of the energy storage module 20 is controlled according to the current-sharing bus signal V_ishare (step S20), and the energy storage module 20 is used to compensate the fluctuations of the input current of the power module 10 (step S30). In particular, the operation mode described in step S20 includes a pre-charging mode or a standby mode that the energy storage module 20 operates in, which will be described in detail later.

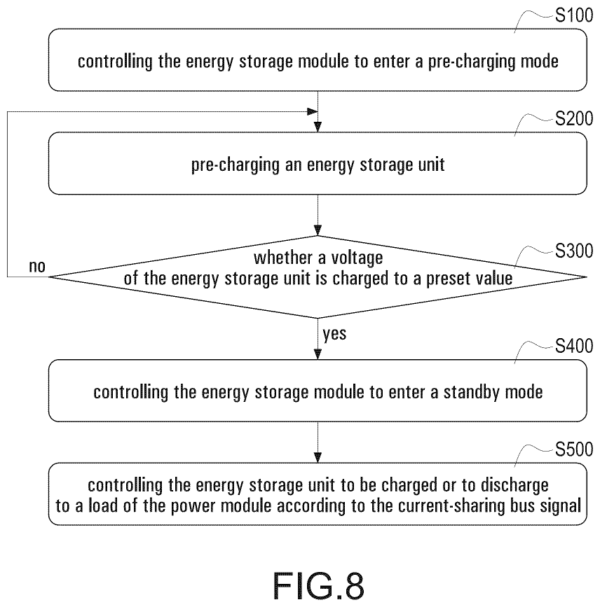

Specifically, please refer to FIG. 8, which shows a flowchart of the method of controlling the energy storage module in detail according to the present disclosure, and also refer to FIG. 1 to FIG. 4. The method of controlling the energy storage module 20 in detail include the following steps. First, after the energy storage module 20 is connected to the power module 10, the energy storage module 20 is controlled to enter the pre-charging mode (step S100), and the energy storage unit 22 of the energy storage module 20 is pre-charged (step S200). Therefore, through the pre-charging operation, the voltage of the energy storage unit 22 can be charged to a preset value. Afterward, it is determined whether the voltage of the energy storage unit 22 is charged to the preset value (step S300). If the determination in step S300 is “no”, step S200 is executed to continuously pre-charge the energy storage unit 22.

In particular, during the pre-charging operation of the energy storage unit 22 of the energy storage module 20 of the present disclosure, there are two purposes that needs to be achieved. First, the energy storage unit 22 is prevent from causing the overload of the power module 10 during the pre-charging process. Second, the energy storage unit 22 is prevent from causing a sudden change in the input current of the power module 10 during the pre-charging process. Therefore, the present disclosure further proposes the following solutions.

Please refer to FIG. 5, which shows a block diagram of a control loop of pre-charging an energy storage unit according to the present disclosure. The current-sharing bus signal V_ishare is sampled to acquire a current-sharing bus sampling signal Vsamp, and the operation mode of the energy storage module 20 is controlled according to a difference between a reference signal Vref and the current-sharing bus sampling signal Vsamp. In the pre-charging mode, the reference signal Vref is set to k times a rated value of the current-sharing bus signal V_ishare, where k is less than 1, and the rated value of the current-sharing bus signal V_ishare represents the output current of the power module 10 at rated power. In the standby mode, the reference signal Vref represents an average power generated by the power module 10, and the reference signal Vref is acquired by processing the current-sharing bus signal V_ishare. It should be understood that there are many ways to acquire the above-mentioned reference signal Vref, for example but not limited to, the reference signal Vref is the average value of the current-sharing bus sampling signal Vsamp over a period of time, or the reference signal Vref is the value acquired by filtering the current-sharing bus sampling signal Vsamp.

When the energy storage unit 22 is pre-charged, the relationship between the reference signal Vref and the current-sharing bus sampling signal Vsamp is always detected. The current-sharing bus signal V_ishare of the power module 10 itself is used as a feedback signal to represent the output current of the power module 10, and there is no need to use an additional output current sampling circuit for the power module 10. In addition, in order to avoid overloading of the power module 10, the reference signal Vref=k*V_Ishare_full, where V_Ishare_full is a value of the current-sharing bus signal V_ishare corresponding to the output current of the power module 10 at full load power (rated power), and where k is less than 1. The purpose is to control the power module 10 not to pre-charge the energy storage unit 22 when it is close to full load in the pre-charging mode so as to avoid overloading of the power module 10.

For the convenience of explanation, it is assumed that when the power module 10 at rated power, the current-sharing bus signal V_ishare is 7 volts. In one condition, the reference signal Vref is set to 6 volts, that is, k=85.71%. When the current-sharing bus sampling signal Vsamp (for example, 3 volts) is less than the reference signal Vref, an error acquired by the difference between the reference signal Vref and the current-sharing bus sampling signal Vsamp is positive. Then the error is compensated by, for example but not limited to, a PI controller, to generate a positive current reference signal Iref, that is, the current reference signal of the bidirectional DC-to-DC converter 21. Furthermore, an error acquired by the difference between an inductor current sampling signal iL in the bidirectional DC-to-DC converter 21 and the current reference signal Iref is compensated by, for example but not limited to, a PI controller, to finally generate a control signal Duty to control a duty cycle of switches in the bidirectional DC-to-DC converter 21. In this condition, the power module 10 can continuously pre-charge the energy storage unit 22.

When the current-sharing bus sampling signal Vsamp (for example, 6.5 volts) is greater than the reference signal Vref (6 volts), the error acquired by the difference between the reference signal Vref and the current-sharing bus sampling signal Vsamp is negative. Then the error is compensated by the PI controller, such that the current reference signal Iref gradually reduces to zero, and finally the bidirectional DC-to-DC converter 21 is controlled to stop working. In this condition, the power module 10 interrupts the pre-charging of the energy storage unit 22.

In this example, during the process of pre-charging the energy storage unit 22 by the power module 10, it is necessary to ensure that the power module 10 does not exceed a certain preset loading. Therefore, when the output power of the power module 10 does not exceed 85.71% of the full load power, the power module 10 can continuously pre-charge the energy storage unit 22. When the output power of the power module 10 exceeds 85.71% of the full load power, the energy storage unit 22 is no longer pre-charged. In some embodiments, k may be set by estimating an average load according to the load conditions.

As mentioned above, in the pre-charging mode, in addition to avoiding the overload of the power module 10, it is also necessary to avoid that the current for charging the energy storage unit 22 from the power module 10 from becomes excessively large during the rapid pre-charging, thereby causing a sudden change in the input current of the power module 10. Therefore, in the pre-charging mode, it is necessary to control the current for charging the energy storage unit 22 from the power module 10 not to exceed a predetermined current-limiting value. In one embodiment, the predetermined current-limiting value may be set as a fixed value, but it is not limited to this. In other embodiments, the predetermined current-limiting value may be set as a first current-limiting value with a fixed value in a first pre-charging stage, and in a second pre-charging stage, the predetermined current-limiting value may be set as a value related to a power value that the power module 10 charges the energy storage unit 22 and/or a value related to a voltage of the energy storage unit 22.

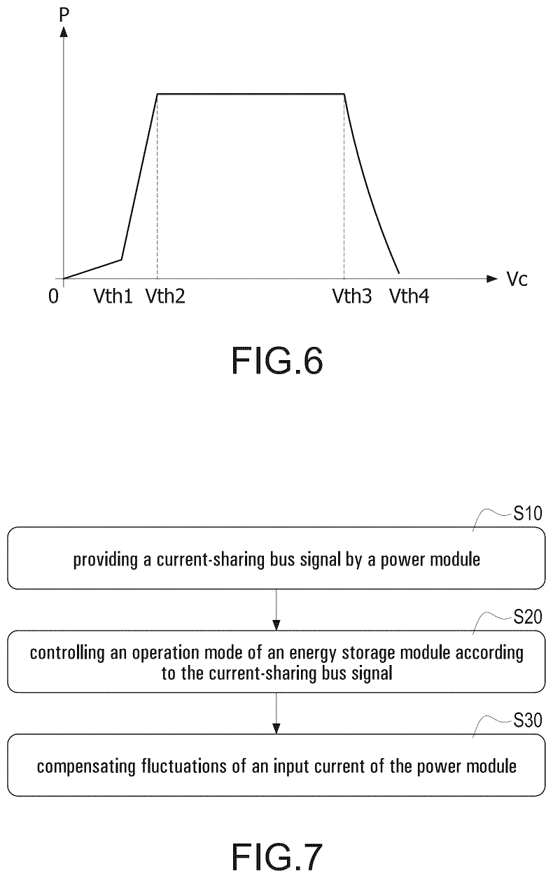

Please refer to FIG. 6, which shows a work waveform diagram of pre-charging the energy storage unit according to the present disclosure. As shown in FIG. 6, the horizontal axis represents the voltage Vc of the energy storage unit 22, and the vertical axis represents the output power of the power module 10. In order to prevent the energy storage unit 22 from being pre-charged with a large current (high power) at the beginning, which may affect the life of the energy storage unit 22, and to prevent the energy storage unit 22 from causing a sudden change in the input current of the power module 10 during the pre-charging process, a small current is usually used for charging at the beginning of pre-charging (when the voltage Vc of the energy storage unit 22 is small). For example, a small constant current (relatively small power) is used for charging.

Therefore, as shown in FIG. 6, when the voltage Vc of the energy storage unit 22 is less than a first voltage threshold Vth1, the energy storage module 20 is controlled to enter the first pre-charging stage, and the current for charging the energy storage unit 22 from the power module 10 is controlled not to exceed the first current-limiting value during the first pre-charging stage.

Afterward, when the voltage Vc of the energy storage unit 22 reaches the first voltage threshold Vth1, the energy storage module 20 is controlled to enter the second pre-charging stage, and the current for charging the energy storage unit 22 from the power module 10 is controlled not to exceed a ratio between a first power threshold and the voltage Vc of the energy storage unit 22 to enter a power-limited charging. Specifically, when entering the second pre-charging stage, the first power threshold is controlled to gradually increase from the power value of charging the energy storage unit 22 by the power module 10 at the end of the first pre-charging stage to a maximum power limit. In this condition, the voltage Vc of the energy storage unit 22 is increased to a second voltage threshold Vth2, and the power value of charging the energy storage unit 22 remains unchanged at the maximum power limit.

When the power value of charging the energy storage unit 22 by the power module 10 reaches the maximum power limit, the energy storage unit 22 is charged at the maximum power limit until the voltage Vc of the energy storage unit 22 reaches a third voltage threshold Vth3, and then the first power threshold is controlled to gradually decrease from the maximum power limit until the voltage Vc of the energy storage unit 22 reaches the preset value (for example, a fourth voltage threshold Vth4), thereby gradually exiting the pre-charging mode.

Incidentally, during the pre-charging process of FIG. 6, even if when entering the high-power pre-charging in the second pre-charging stage, it is also limited by the control loop mechanism illustrated in FIG. 5 to ensure that the power module 10 does not become overloaded.

Please refer to FIG. 8 again. When the voltage Vc of the energy storage unit 22 is charged to the preset value, the energy storage module 20 is controlled to enter the standby mode (step S400), and the pre-charging mode is ended. In the standby mode, the energy storage unit 22 is controlled to be charged by the power module 10 or to discharge to the load 50 of the power module 10 according to the current-sharing bus signal V_ishare (step S500). In other words, after the pre-charging mode is ended, the energy storage module 20 enters the standby mode to receive the current-sharing bus signal V_ishare provided by the power module 10, and the energy storage unit 22 is controlled to be charged by the power module 10 or discharge to the load 50 of the power module 10 according to the current-sharing bus signal V_ishare. Specifically, in the standby mode, when the current-sharing bus sampling signal Vsamp is greater than the reference signal Vref, the energy storage module 20 is controlled to operate in the discharging mode so that the energy storage unit 22 releases energy to the load 50. On the contrary, when the current-sharing bus sampling signal Vsamp is less than the reference signal Vref, the energy storage module 20 is controlled to operate in the charging mode to store energy.

In summary, the present disclosure has the following features and advantages:
1. By providing or receiving current through the energy storage module 20, the output current of the power module 10 does not need to rapidly increase or decrease in a short period of time. As a result, the power module 10 does not need to quickly increase or decrease the current drawn from its input power source so that the input current of the power module 10 can be maintained unchanged or without a sudden change, thereby reducing the impact on the power grid.
2. It is to prevent the energy storage unit 22 from causing the overload of the power module 10 during the pre-charging process.
3. It is to prevent the energy storage unit 22 from causing a sudden change in the input current of the power module 10 during the pre-charging process.
4. The energy storage unit 22 is kept to have a normal service life with the method for the pre-charging process.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method of controlling an energy storage module, wherein the energy storage module comprises a bidirectional DC-to-DC converter and an energy storage unit and a first terminal of the bidirectional DC-to-DC converter is connected to the energy storage unit, the method comprising: controlling an operation mode of the energy storage module according to a current-sharing bus signal provided by a power module connected to a second terminal of the bidirectional DC-to-DC converter, wherein the energy storage module is configured to compensate fluctuations of an input current of the power module.

2. The method of controlling the energy storage module according to claim 1, further comprising: controlling the energy storage module to enter a pre-charging mode to pre-charge the energy storage unit after the energy storage module is connected to the power module; controlling the energy storage module to enter a standby mode when a voltage of the energy storage unit is charged to a preset value, wherein in the standby mode, the energy storage unit is controlled to be charged or discharge to the power module according to the current-sharing bus signal.

3. The method of controlling the energy storage module according to claim 1, further comprising: sampling the current-sharing bus signal to acquire a current-sharing bus sampling signal, and controlling the operation mode of the energy storage module according to a difference between a reference signal and the current-sharing bus sampling signal.

4. The method of controlling the energy storage module according to claim 3, further comprising: generating a current reference signal corresponding to the bidirectional DC-to-DC converter according to the difference between the reference signal and the current-sharing bus sampling signal, and controlling the operation mode of the energy storage module according to the current reference signal and an inductor current of the bidirectional DC-to-DC converter.

5. The method of controlling the energy storage module according to claim 3, further comprising: in a pre-charging mode, setting the reference signal to be k times a rated value of the current-sharing bus signal, and k being less than 1, wherein the rated value of the current-sharing bus signal represents an output current of the power module at rated power.

6. The method of controlling the energy storage module according to claim 3, wherein in a standby mode, the reference signal represents an average power of the power module.

7. The method of controlling the energy storage module according to claim 5, further comprising: in the pre-charging mode, controlling a current for charging the energy storage unit not to exceed a predetermined current-limiting value.

8. The method of controlling the energy storage module according to claim 7, wherein the predetermined current-limiting value is set to be a fixed value.

9. The method of controlling the energy storage module according to claim 7, wherein the predetermined current-limiting value is set to be a first current-limiting value with a fixed value in a first pre-charging stage, and the predetermined current-limiting value is set to be a value related to a power value that the power module charges the energy storage unit and/or a value related to a voltage of the energy storage unit in a second pre-charging stage.

10. The method of controlling the energy storage module according to claim 9, further comprising: controlling the energy storage module to enter the first pre-charging stage when the voltage of the energy storage unit is less than a first voltage threshold, and controlling a current for charging the energy storage unit not to exceed the first current-limiting value during the first pre-charging stage.

11. The method of controlling the energy storage module according to claim 9, further comprising: controlling the energy storage module to enter the second pre-charging stage when the voltage of the energy storage unit reaches the first voltage threshold, and controlling a current for charging the energy storage unit not to exceed a ratio between a first power threshold and the voltage of the energy storage unit during the second pre-charging stage.

12. The method of controlling the energy storage module according to claim 11, further comprising: controlling the first power threshold to gradually increase from the power value of charging the energy storage unit at the end of the first pre-charging stage to a maximum power limit when entering the second pre-charging stage.

13. The method of controlling the energy storage module according to claim 12, further comprising: charging the energy storage unit at the maximum power limit until the voltage of the energy storage unit reaches a third voltage threshold when the power value of charging the energy storage unit reaches the maximum power limit, and then controlling the first power threshold to gradually decrease from the maximum power limit until the voltage of the energy storage unit reaches the preset value, thereby gradually exiting the pre-charging mode.

14. The method of controlling the energy storage module according to claim 3, further comprising: in the standby mode, controlling the energy storage module to operate in the discharging mode when the current-sharing bus sampling signal is greater than the reference signal so that the energy storage unit releases energy to the load; controlling the energy storage module to operate in the charging mode to store energy when the current-sharing bus sampling signal is less than the reference signal.

15. An energy storage module, comprising:
a bidirectional DC-to-DC converter and an energy storage unit, wherein a first terminal of the bidirectional DC-to-DC converter is connected to the energy storage unit, and a second terminal of the bidirectional DC-to-DC converter is connected to an output terminal of a power module; and
a controller, configured to execute the method in claim 1.

16. A power supply system comprising:
at least one power module, wherein an output terminal of each power module is connected in parallel to a load, and each power module is configured to convert its own output current into a voltage signal to a current-sharing bus, and
at least one energy storage module, each energy storage module having an output terminal connected together, and each energy storage module comprising a bidirectional DC-to-DC converter and an energy storage unit, wherein a first terminal of the bidirectional DC-to-DC converter is connected to the energy storage unit, and a second terminal of the bidirectional DC-to-DC converter is connected to the output terminal of the power module, and each energy storage module further comprises a controller, configured to execute the method in claim 1; wherein the voltage signal on the current-sharing bus is the current-sharing bus signal.

17. The power supply system according to claim 16, wherein the at least one power module is disposed in the same power shelf.

18. The power supply system according to claim 16, wherein the at least one energy storage module is disposed in the same power shelf.
